(19) United States
(12) Patent Application Publication
(10) Pub. No.: US 2010/0011660 A1
(43) Pub. Date: Jan. 21, 2010

(54) Water reservoir for plants

(76) Inventor: Patrick J. Clancy, Martinez, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/219,291

(22) Filed: Jul. 18, 2008

(51) Int. Cl. A01G 29/00

(52) U.S. Cl. 47/48.5

(57) ABSTRACT

The water reservoir for plants comprises a single sheet of flexible plastic material. Fasteners are employed to join the ends of the sheet together to form a continuous circle or collar. The sheet is positioned in a trench that is excavated to receive the new plant, thereby forming a barrier around the roots of the new plant. After the plant is placed in the excavated trench, dirt is used to fill the space outside the walls of the sheet. The space inside the walls of the sheet, containing the root ball, is filled with water.

### BACKGROUND OF THE INVENTION

1. Field of the Invention

The present invention generally relates to landscaping and gardening apparatus and method, and more particularly to a water reservoir for plants that forms a water reservoir around the roots of plants when planting or replanting.

2. Description of the Related Art

Young plants, such as bushes, trees and the like, are most vulnerable when first planted. It is important that the root system of the young plants receive an abundant and effective amount of water to prevent the root system from drying out or freezing. Providing water at the ground surface can be ineffective, since the water may run off without penetrating the ground to reach the root system. An inexpensive device and method for retaining water around the root system would certainly be welcomed both by professional landscapers and home gardeners. Thus, a water reservoir for plants solving the aforementioned problems is desired.

### SUMMARY OF THE INVENTION

The water reservoir for plants comprises a single sheet of flexible plastic material. The preferred material is Sentra® (Sentra is a registered trademark of Alphagary Corporation of Leominster, Mass.), which is a polyethylene based resin having a zinc-based flame retardant and properties similar to polyvinyl chloride (PVC). Fasteners are employed to join the ends of the sheet together to form a continuous circle or collar. The sheet is positioned in a trench that is excavated to receive the new plant, thereby forming a barrier around the roots of the new plant. After the plant is placed in the excavated trench, dirt is used to fill the space outside the walls of the sheet. The space inside the walls of the sheet, containing the root ball, is filled with water.

Accordingly, the water reservoir for plants effectively provides a barrier for retaining water adjacent the root ball of new plants to enhance survival and healthy growth of the new plant. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a water reservoir for plants according to the present invention.

FIG. 2 is a perspective view of a water reservoir for plants according to the present invention.

FIG. 3 is a partial, exploded, perspective view of a water reservoir for plants according to the present invention.

FIG. 4 is an environmental, perspective view of step 1 in preparing a water reservoir for plants according to the present invention.

FIG. 5 is an environmental, perspective view of step 2 in preparing a water reservoir for plants according to the present invention.

FIG. 6 is an environmental, perspective view of step 3 in preparing a water reservoir for plants according to the present invention.

Similar reference characters denote corresponding features consistently throughout the attached drawings.

### DETAILED DESCRIPTION OF THE PREFERRED EMBODIMENTS

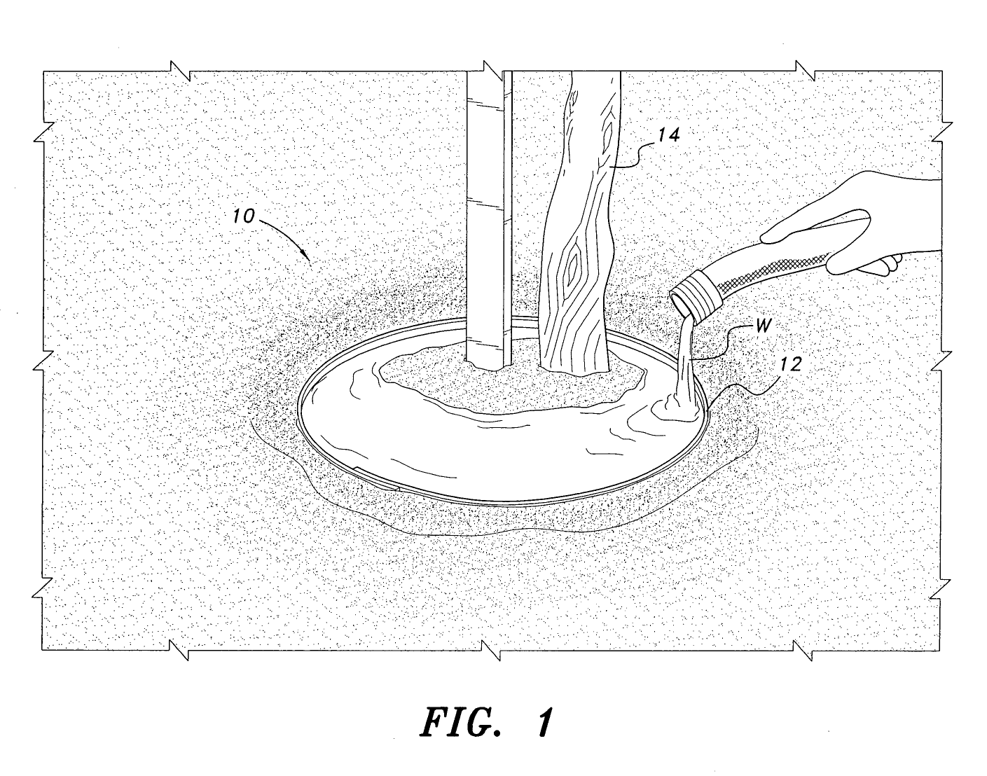

Attention is first directed to FIG. 1, wherein the water reservoir for plants is generally indicated at 10. As shown, reservoir 10 is being filled with water W. Barrier 12 defines the perimeter of reservoir 10. Barrier 12 will extend above ground level for approximately two or three inches. A plant, such as tree 14, has its root ball planted in the center of reservoir 10.

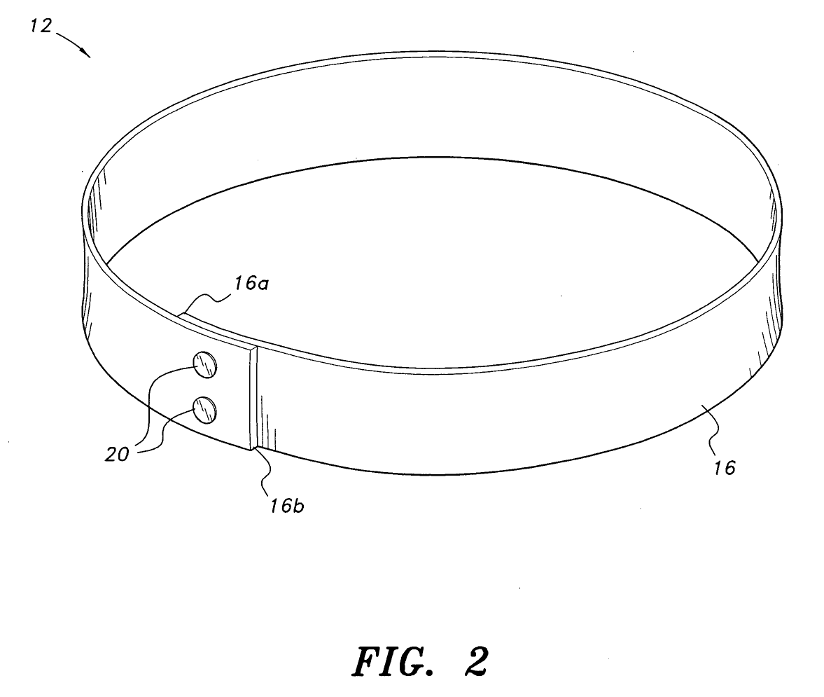

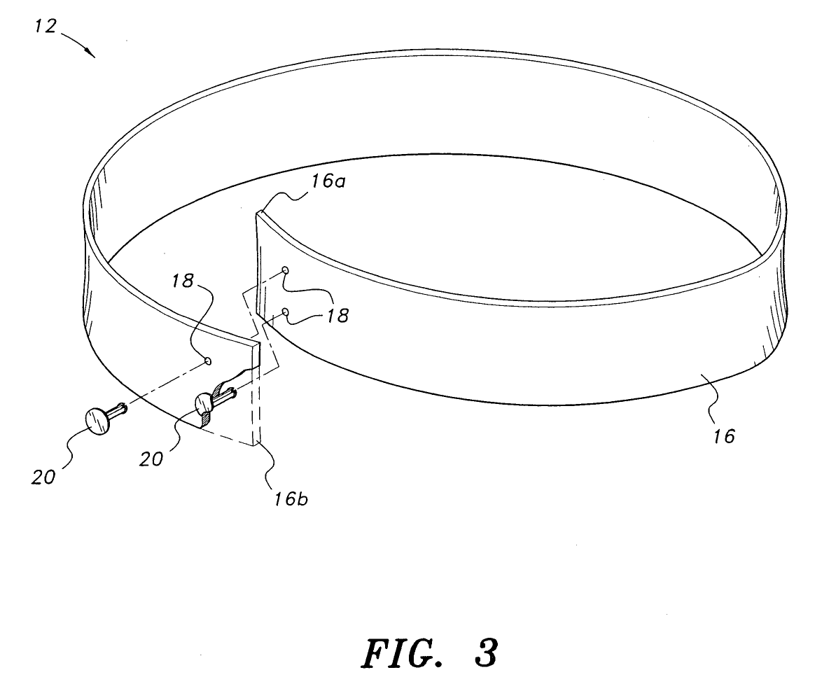

As best seen in FIGS. 2 and 3, barrier 12 comprises a flexible, imperforate sheet 16 having ends 16a and 16b. Sheet 16 has a thickness of approximately ⅛ of an inch. The sheet 16 may be cut to different lengths and widths, depending on the size of the plant and the diametrical dimensions of the barrier to be formed therearound. The preferred material for sheet 16 is Sentra® (Sentra is a registered trademark of Alphagary Corporation of Leominster, Mass.), which is a polyethylene based resin having a zinc-based flame retardant and properties similar to polyvinyl chloride (PVC). Holes 18 are drilled at each end 16a, 16b. The holes 18 are sized to accept snap-in fasteners 20 to join ends 16a, 16b to form the continuous barrier 12. Automotive-type nylon fasteners, e.g., snap-in push pin with split shafts, have proven to be effective in joining and holding the ends together during extended use.

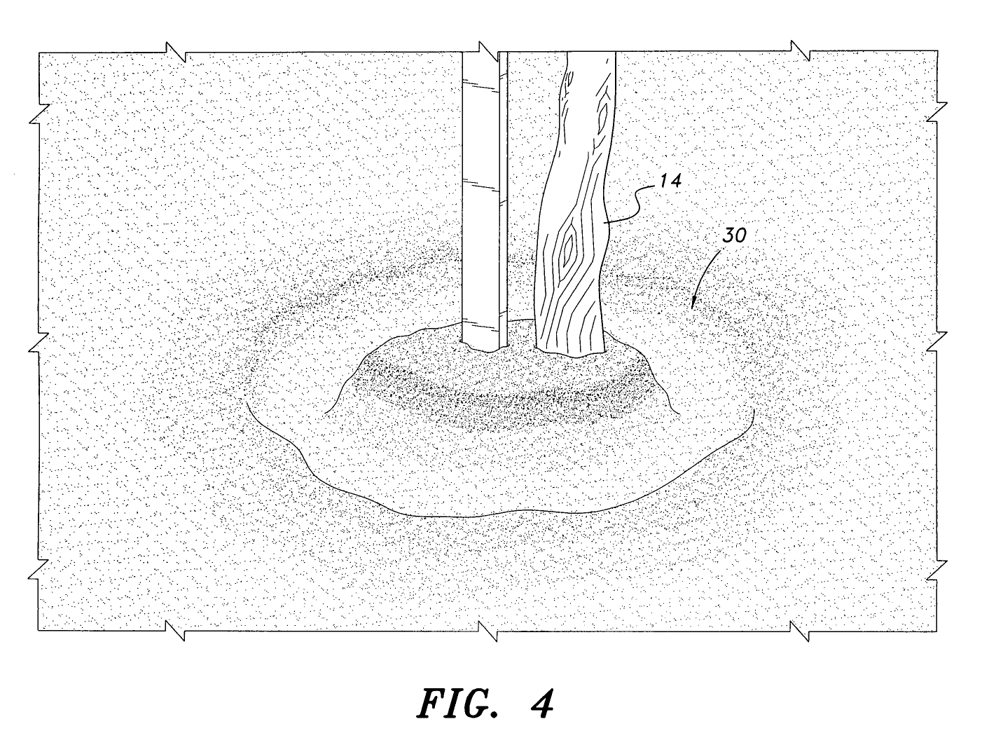

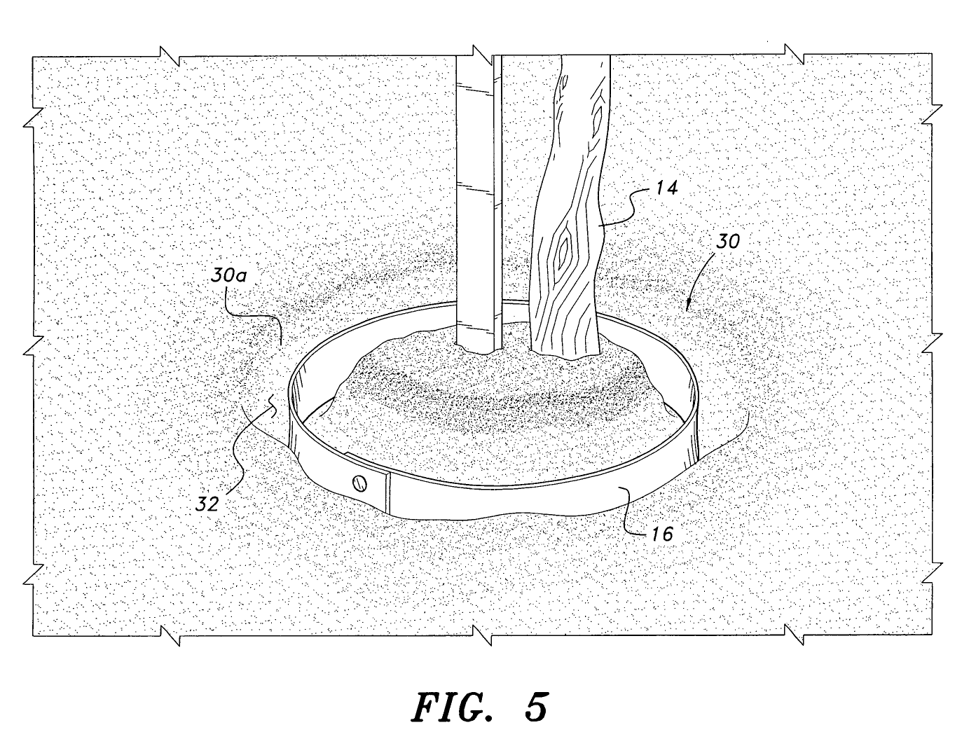

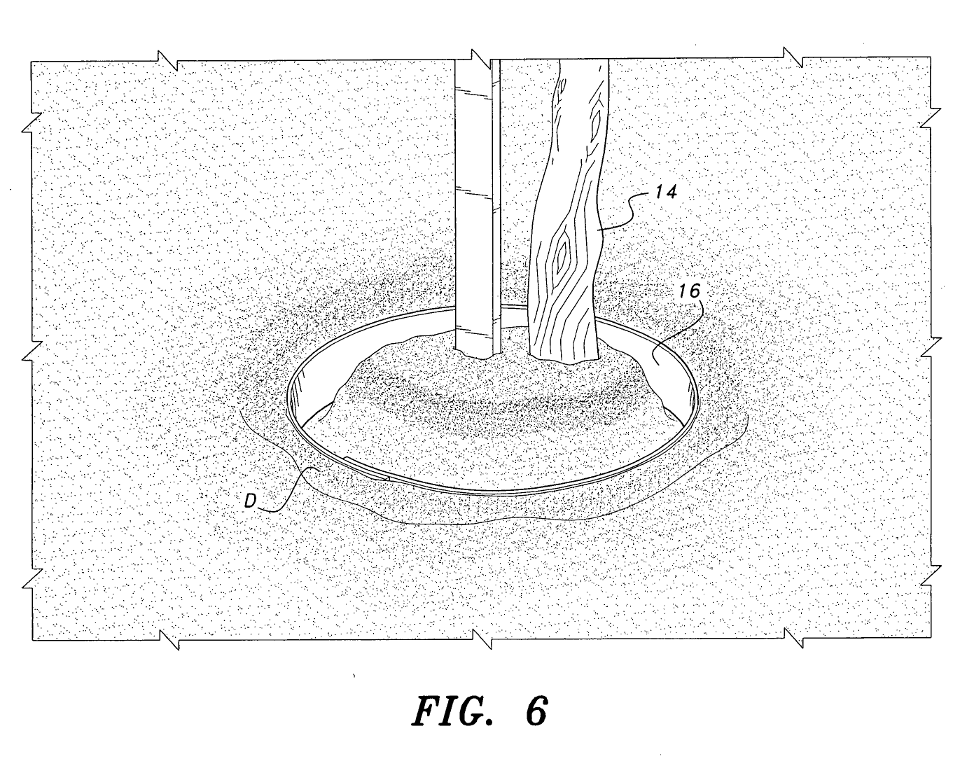

FIGS. 4-6 are illustrative of the steps involved to construct the reservoir 10. As shown in FIG. 4, step one requires that an excavation 30 be dug around the predetermined position of plant 14. The depth and diameter of excavation 30 will be determined on the recommended directions that accompany most plants, which are based on the size of the root ball. Step two requires that the sheet 16 be placed in the excavation and the ends joined to form a circular barrier around the plant, as shown in FIG. 5. Note that a space 32 is formed between the wall of the barrier and the circumferential wall 30a of the excavation. Step three requires that space 32 be filled with dirt D (FIG. 6). The final step requires that the reservoir be filled with water as shown in FIG. 1.

It is to be understood that the present invention is not limited to the embodiment described above, but encompasses any and all embodiments within the scope of the following claims.

I claim:

1. A water reservoir for plants, comprising:
an elongate sheet of flexible material having a first end and a second end, a plurality of openings being formed in the first end and the second end; and
a plurality of fasteners disposed in the openings to join the first end to the second end.

2. The water reservoir for plants according to claim 1, wherein said elongate sheet is imperforate.

3. The water reservoir for plants according to claim 1, wherein said flexible material is made from plastic.

4. The water reservoir for plants according to claim 1, wherein said plurality of fasteners are nylon pin snap fasteners.

5. A water reservoir for plants, comprising:
an elongate sheet of imperforate, flexible material having a first end and a second end, a plural openings being formed in the first end and the second end; and
a plurality of pin snap fasteners disposed in the openings to join the first end to the second end.

6. The water reservoir for plants according to claim 5, wherein said flexible material is made from plastic.

7. A method of constructing a water reservoir for plants comprising the steps of:
excavating a circular hole of predetermined size, the hole having a circumferential wall;
positioning a plant in a central area of the hole;
positioning a barrier in the hole, the barrier being spaced from the plant and the circumferential wall;
filling the space between the barrier and the circumferential wall with dirt; and
filling the space between the barrier and the plant with water.

8. The method of constructing a water reservoir for plants according to claim 7, wherein said barrier comprises an elongate sheet of imperforate, flexible material, the elongate sheet having a first end and a second end and a plurality of openings formed in the first end and the second end, and wherein said step of positioning said barrier in said hole further includes the step of fastening the first end to the second end with a plurality of snap-in push pins.
